(19) United States
(12) Patent Application Publication
(10) Pub. No.: US 2017/0248820 A1
(43) Pub. Date: Aug. 31, 2017

(54) TRANSFLECTIVE LIQUID CRYSTAL DISPLAY

(71) Applicant: Innolux Corporation, Chu-Nan (TW)

(72) Inventors: Masahiro YOSHIGA, Chu-Nan (TW); Yoshitaka HARUYAMA, Chu-Nan (TW); Satoru TAKAHASHI, Chu-Nan (TW)

(73) Assignee: Innolux Corporation, Chu-Nan (TW)

(21) Appl. No.: 15/052,919

(22) Filed: Feb. 25, 2016

(51) Int. Cl. G02F 1/1335; G02F 1/1343

(52) U.S. Cl. CPC G02F 1/133555; G02F 1/134309; G02F 2001/134345

(57) ABSTRACT

A transflective liquid crystal display includes a plurality of pixels. At least one of the plurality of the pixels includes a first sub-pixel having a blue color and a second sub-pixel having a color different from the blue color. Each of the first sub-pixel and the second sub-pixel has a transmissive region and a reflective region. A ratio of the transmissive region to the reflective region of the first sub-pixel is different from a ratio of the transmissive region to the reflective region of the second sub-pixel. A first voltage is applied to the first sub-pixel. A second voltage is applied to the second sub-pixel. The second voltage is different from the first voltage.

### TECHNICAL FIELD

The disclosure relates in general to a liquid crystal display, and more particularly to a transflective liquid crystal display.

### BACKGROUND

Today, electronic products with display panels, such as smart phones, tablet personal computers (i.e. tablet PC, flat PC, ex: iPad), laptops, monitors, and televisions, are necessary tools for work and leisure in the daily life. Liquid crystal display (LCD) panel is the most popular display panel in use.

For a LCD panel applicable to a flat display, an electronic visual display and an image display, the liquid crystal molecules aligned between two transparent electrodes rotate continuously depending on the polarity and magnitude of the electric field when the electric field is applied, and different grey scale expression can be adjusted and realized by varying the applied voltage. LCD panel possesses the excellent characteristics such as compact in size, light weight, easy to carry, having reasonable price, higher display quality and operation reliability. Also, viewer's eyes feel much more comfortable looking at a LCD panel. Older cathode ray tube (CRT) monitors have been replaced by LCD panels. Currently, LCD panels provide a versatile choice in sizes, shapes and resolutions for the consumers.

However, for a transflective LCD, white points of a reflective mode (R-mode) and a transmissive mode (T-mode) are different. White point correction (WPC) is a technique using different RGB voltage to make a neutral white (for example D65), but the voltages are low so a LC efficiency is low.

### SUMMARY

The disclosure is directed to a transflective liquid crystal display. According to some embodiments, a white point and a LC efficiency can be improved at the same time.

According to an embodiment of the disclosure, a transflective liquid crystal display is provided. The transflective liquid crystal display comprises a plurality of pixels. At least one of the plurality of the pixels comprises a first sub-pixel having a blue color and a second sub-pixel having a color different from the blue color. Each of the first sub-pixel and the second sub-pixel has a transmissive region and a reflective region. A ratio of the transmissive region to the reflective region of the first sub-pixel is different from a ratio of the transmissive region to the reflective region of the second sub-pixel. A first voltage is applied to the first sub-pixel. A second voltage is applied to the second sub-pixel. The second voltage is different from the first voltage.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1A shows a pixel of a liquid crystal display according to an embodiment.

FIG. 1B shows voltage-dependent intensity curves of a liquid crystal display according to an embodiment.

FIG. 1C is a schematic diagram illustrating display colors expressed by a liquid crystal display according to an embodiment.

FIG. 1D shows a schematic cross-sectional view taken along a D-D′ line of FIG. 1A.

FIG. 2A shows a pixel of a liquid crystal display according to an embodiment.

FIG. 2B shows voltage-dependent intensity curves of a liquid crystal display according to an embodiment.

FIG. 2C is a schematic diagram illustrating display colors expressed by a liquid crystal display according to an embodiment.

FIG. 3A shows a pixel of a liquid crystal display according to an embodiment.

FIG. 3B shows voltage-dependent intensity curves of a liquid crystal display according to an embodiment.

FIG. 3C is a schematic diagram illustrating display colors expressed by a liquid crystal display according to an embodiment.

FIG. 4 shows a pixel of a liquid crystal display according to an embodiment.

FIG. 5 shows a pixel of a liquid crystal display according to an embodiment.

FIG. 6A shows a pixel of a liquid crystal display of a comparative example.

FIG. 6B shows voltage-dependent intensity curves of the liquid crystal display of the comparative example.

FIG. 6C is a schematic diagram illustrating display colors expressed by the liquid crystal display of the comparative example.

### DETAILED DESCRIPTION

According to an embodiment of the disclosure, in a transflective liquid crystal display, a ratio of a transmissive region (or area) to a reflective region (or area) of a blue sub-pixel is different from a ratio of a transmissive region to a reflective region of a sub-pixel having a color different from the blue color. In addition, in a method for operating the transflective liquid crystal display, a voltage applied to the sub-pixel having the color different from the blue color is different from a voltage applied to the blue sub-pixel. According to some embodiments, the result shows that a LC efficiency and a white point of the transflective liquid crystal display can be improved at the same time. Detailed descriptions of the embodiments of the disclosure are disclosed below with accompanying drawings. In the accompanying diagrams, the same numeric or symbol designations indicate the same or similar components. It should be noted that accompanying drawings are simplified so as to provide clear descriptions of the embodiments of the disclosure, and the following detailed description are exemplary and explanatory only and are not restrictive of the disclosed embodiments as claimed. Anyone who is skilled in the technology field of the disclosure can make necessary modifications or variations to the structures according to the needs in actual implementations.

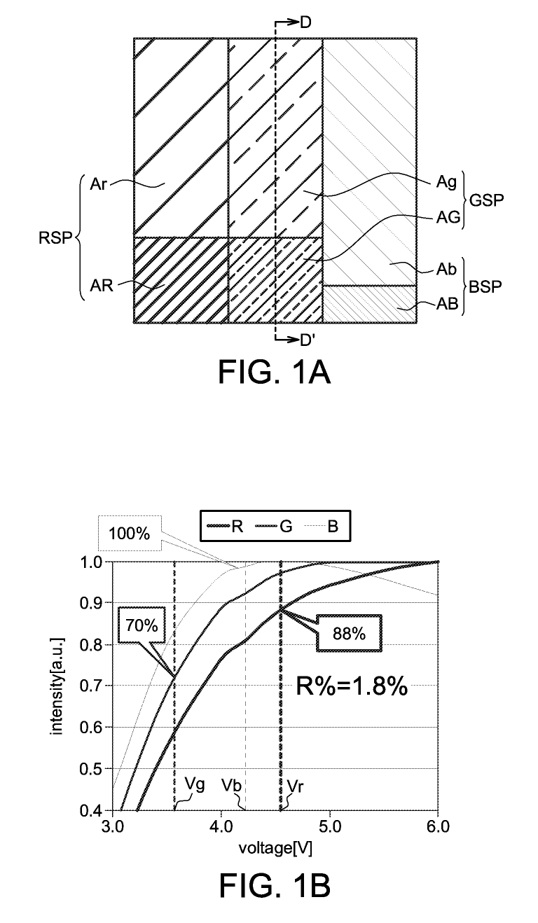

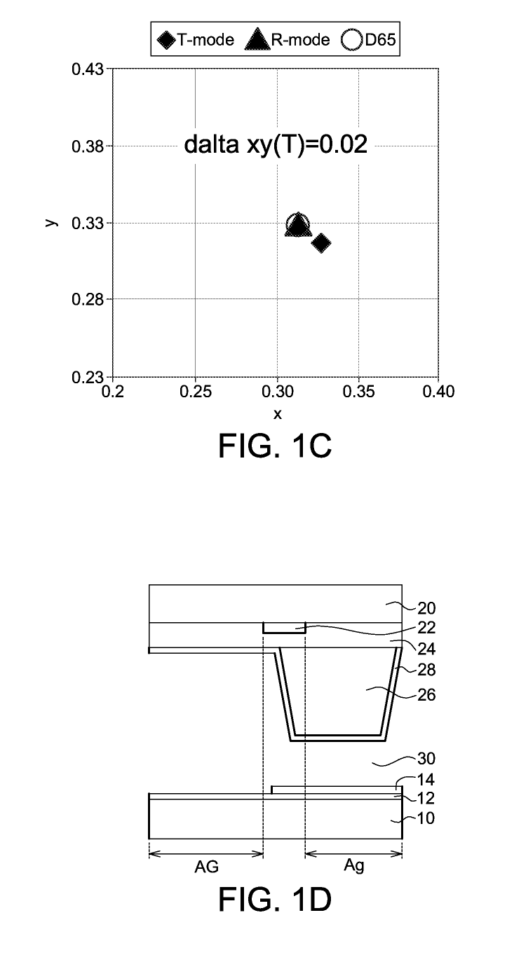

FIG. 1A shows a pixel of a liquid crystal display according to a first embodiment. In this embodiment, the liquid crystal display is a transflective liquid crystal display. The pixel comprises a red sub-pixel RSP, a green sub-pixel GSP and a blue sub-pixel BSP. A shielding layer (not shown in FIG. 1A for simplicity) is used to define a transmissive region and a reflective region for each of the red sub-pixel RSP, the green sub-pixel GSP and the blue sub-pixel BSP. In details, the red sub-pixel RSP comprises a transmissive region AR and a reflective region Ar. The green sub-pixel GSP comprises a transmissive region AG and a reflective region Ag. The blue sub-pixel BSP comprises a transmissive region AB and a reflective region Ab. Generally, the transmissive region can also be expressed as a transmissive aperture ratio, and the reflective region can also be expressed as a reflective aperture ratio.

FIG. 1D shows a schematic cross-sectional view taken along a D-D′ line of FIG. 1A. The transflective liquid crystal display includes a first substrate 10, a second substrate 20, and a liquid crystal layer 30 between the first substrate 10 and the second substrate 20. The first substrate 10 can be an array substrate, and the second substrate 20 can be a color filter substrate. A transmissive electrode 12 and a reflective electrode 14 are formed on the first substrate 10. A shielding layer 22, a color layer 24, a step on CF (color filter) 26, and a transmissive electrode 28 are formed on the second substrate 20. The step on CF 26 is used to form different cell gaps for the transmissive region (for example, AG) and the reflective region (for example, Ag). The transmissive electrodes 12, 28 can be indium tin oxide (ITO), and the reflective electrode 14 can be metal. For simplicity, FIG. 1A only shows the transmissive regions AR, AG, AB and the reflective regions Ar, Ag, Ab, and some other elements (such as electrodes, substrates, shielding layer, etc.) are not shown.

Referring to FIG. 1A, a sum of the transmissive region AR and the reflective region Ar of the red sub-pixel RSP, a sum of the transmissive region AG and the reflective region Ag of the green sub-pixel GSP, and a sum of the transmissive region AB and the reflective region Ab of the blue sub-pixel BSP are the same. A ratio of the transmissive region AB to the reflective region Ab of the blue sub-pixel BSP is different from a ratio of the transmissive region AR to the reflective region Ar of the red sub-pixel RSP, and is different from a ratio of the transmissive region AG to the reflective region Ag of the green sub-pixel GSP. In the present specification, the ratio of the transmissive region to the reflective region means an area ratio of the transmissive region to the reflective region. For example, the transmissive region AB of the blue sub-pixel BSP is less than the transmissive region AR of the red sub-pixel RSP, and is less than the transmissive region AG of the green sub-pixel GSP. In addition, the reflective region Ab of the blue sub-pixel BSP is more than the reflective region Ar of the red sub-pixel RSP, and is more than the reflective region Ag of the green sub-pixel GSP. According to some embodiments, the ratio of the transmissive region AB to the reflective region Ab of the blue sub-pixel BSP can be less than the ratio of the transmissive region AR to the reflective region Ar of the red sub-pixel RSP, and less than the ratio of the transmissive region AG to the reflective region Ag of the green sub-pixel GSP. According to some embodiments, the ratio of the transmissive region AR to the reflective region Ar of the red sub-pixel RSP and the ratio of the transmissive region AG to the reflective region Ag of the green sub-pixel GSP can be the same or different.

In embodiments, a white point of the pixel can be improved by applying suitable voltages. For example, a voltage Vr is applied to the red sub-pixel RSP. A voltage Vg is applied to the green sub-pixel GSP. A voltage Vb is applied to the blue sub-pixel BSP. In some embodiments, the same voltage Vr can be applied to the transmissive region AR and the reflective region Ar of the red sub-pixel RSP, the same voltage Vg can be applied to the transmissive region AG and the reflective region Ag of the green sub-pixel GSP, the same voltage Vb can be applied to the transmissive region AB and the reflective region Ab of the blue sub-pixel BSP. In some embodiments, the voltage Vg can be lower than the voltage Vr. In some embodiments, at least one of the voltage Vr and the voltage Vg can be higher than the voltage Vb.

According to the first embodiment, the voltage Vb is lower than the voltage Vr, and is higher than the voltage Vg.

FIG. 1B shows voltage-dependent intensity curves of the liquid crystal display according to the first embodiment. The (reflectance) intensity (a.u.) is obtained by dividing reflectance measured under voltages applied to a sub-pixel by the maximum reflectance. The (reflectance) intensity (a.u.) can indicate a LC efficiency of the sub-pixel.

FIG. 10 is a schematic diagram illustrating display colors expressed by the liquid crystal display according to the first embodiment. A hollow circle indicates a target white point D65. A solid triangle indicates a reflective white point illuminated by the liquid crystal display. A solid diamond indicates a transmissive white point illuminated by the liquid crystal display.

According to some embodiment, in order to achieve better LC efficiency, the ratios of the transmissive region to the reflection region for sub-pixels of different colors are adjusted, and the voltages applied to sub-pixels of different colors are also adjusted. For different sub-pixels, LC efficiency trends corresponding to voltage are different. With regard to the different LC efficiency trends, the voltages applied to the different sub-pixels can be appropriately adjusted according to requirements. For example, in some embodiments, the voltage applied to the blue sub-pixel can be adjusted such that the reflectance intensity of the blue sub-pixel is 95% to 100%, the voltage applied to the red sub-pixel can be adjusted such that the reflectance intensity of the red sub-pixel is 80% to 100%, the voltage applied to the green sub-pixel can be adjusted such that the reflectance intensity of the green sub-pixel is 65% to 100%. In other embodiments, the voltage applied to the blue sub-pixel can be adjusted such that the reflectance intensity of the blue sub-pixel is 95% to 100%, the voltage applied to the red sub-pixel can be adjusted such that the reflectance intensity of the red sub-pixel is 95% to 100%, the voltage applied to the green sub-pixel can be adjusted such that the reflectance intensity of the green sub-pixel is 95% to 100%. In other embodiments, the voltages applied to the blue sub-pixel, red sub-pixel, and green sub-pixel can be adjusted such that the reflectance intensities of the blue sub-pixel, the red sub-pixel and the green sub-pixel are the same, for example, 100%.

In an embodiment, a deviation value between the target white point D65 and the reflective white point is set to zero (delta xy (R)=0) (FIG. 10). In addition, a transmittance of the liquid crystal display is set to 2.0% (T %=2.0%). Under the above conditions (delta xy (R)=0 and T %=2.0%), a deviation value between the target white point D65 and the transmissive white point being 0.02 (delta xy (T)=0.02) (FIG. 10) is obtained as the voltage Vr (FIG. 1B) applied to the transmissive region AR and the reflective region Ar of the red sub-pixel RSP (FIG. 1A) is 4.6V, the voltage Vg applied to the transmissive region AG and the reflective region Ag of the green sub-pixel GSP is 3.6V, and the voltage Vb applied to the transmissive region AB and the reflective region Ab of the blue sub-pixel BSP is 4.2V. The (reflectance) intensity (LC efficiency) of the red sub-pixel RSP is 88% under the voltage Vr. The intensity of the green sub-pixel GSP is 70% under the voltage Vg. In addition, the intensity of the blue sub-pixel BSP is 100% under the voltage Vb. The reflection of the pixel is 1.8% (R %=1.8%). Accordingly, the delta xy (T) and the R % can be improved under the same T % and delta xy (R).

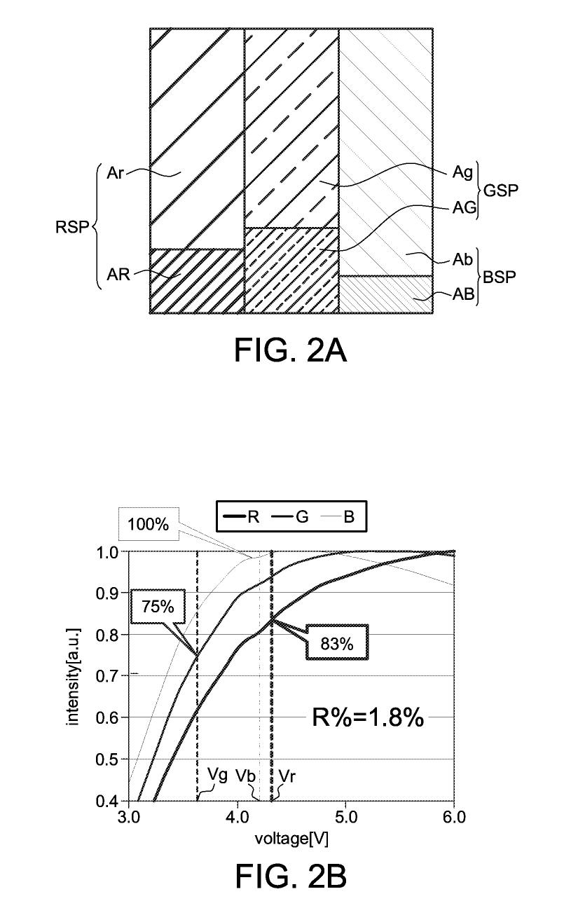

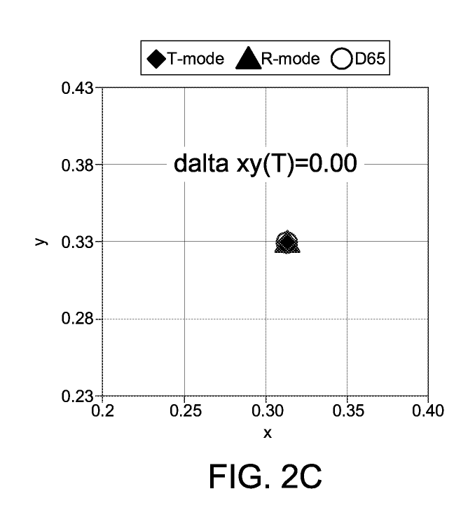

FIG. 2A shows a pixel of a liquid crystal display according to a second embodiment. The sum of the transmissive region AR and the reflective region Ar of the red sub-pixel RSP, the sum of the transmissive region AG and the reflective region Ag of the green sub-pixel GSP, and the sum of the transmissive region AB and the reflective region Ab of the blue sub-pixel BSP are the same. The ratio of the transmissive region AB to the reflective region Ab of the blue sub-pixel BSP, the ratio of the transmissive region AR to the reflective region Ar of the red sub-pixel RSP, and the ratio of the transmissive region AG to the reflective region Ag of the green sub-pixel GSP are different from each other. For example, the transmissive region AR of the red sub-pixel RSP is more than the transmissive region AB of the blue sub-pixel BSP, and is less than the transmissive region AG of the green sub-pixel GSP. In addition, the reflective region Ar of the red sub-pixel RSP is less than the reflective region Ab of the blue sub-pixel BSP, and is more than the reflective region Ag of the green sub-pixel GSP. According to some embodiments, the ratio of the transmissive region AR to the reflective region Ar of the red sub-pixel RSP can be more than the ratio of the transmissive region AB to the reflective region Ab of the blue sub-pixel BSP, and less than the ratio of the transmissive region AG to the reflective region Ag of the green sub-pixel GSP.

According to the second embodiment, the voltage Vb applied to the blue sub-pixel BSP is lower than the voltage Vr applied to the red sub-pixel RSP, and is higher than the voltage Vg applied to the green sub-pixel GSP.

FIG. 2B shows voltage-dependent intensity curves of the liquid crystal display according to the second embodiment. FIG. 2C is a schematic diagram illustrating display colors expressed by the liquid crystal display according to the second embodiment.

In an embodiment, the deviation value between the target white point D65 and the reflective white point is set to zero (delta xy (R)=0) (FIG. 2C). In addition, the transmittance of the liquid crystal display is set to 2.0% (T %=2.0%). Under the above conditions (delta xy (R)=0 and T %=2.0%), the deviation value between the target white point D65 and the transmissive white point being 0.00 (delta xy (T)=0.00) (FIG. 2C) is obtained as the voltage Vr (FIG. 2B) is 4.3V, the voltage Vg is 3.6V, and the voltage Vb is 4.2V. The intensity of the red sub-pixel RSP is 83% under the voltage Vr. The intensity of the green sub-pixel GSP is 75% under the voltage Vg. In addition, the intensity of the blue sub-pixel BSP is 100% under the voltage Vb. The reflection of the pixel is 1.8% (R %=1.8%). Accordingly, the delta xy (T) and the R % can be improved under the same T % and delta xy (R).

In some embodiments, the sum of the transmissive region AB and the reflective region Ab of the blue sub-pixel BSP is different from at least one of the sum of the transmissive region AR and the reflective region Ar of the red sub-pixel RSP and the sum of the transmissive region AG and the reflective region Ag of the green sub-pixel GSP.

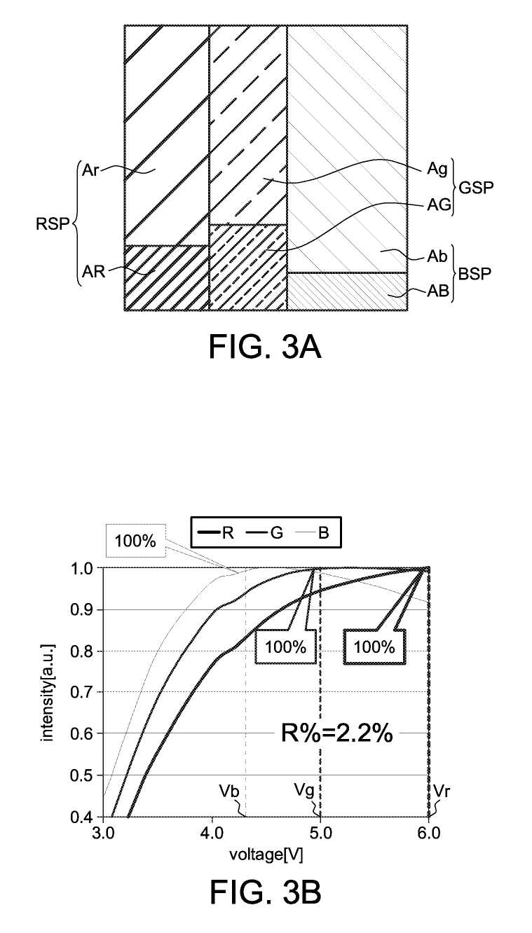

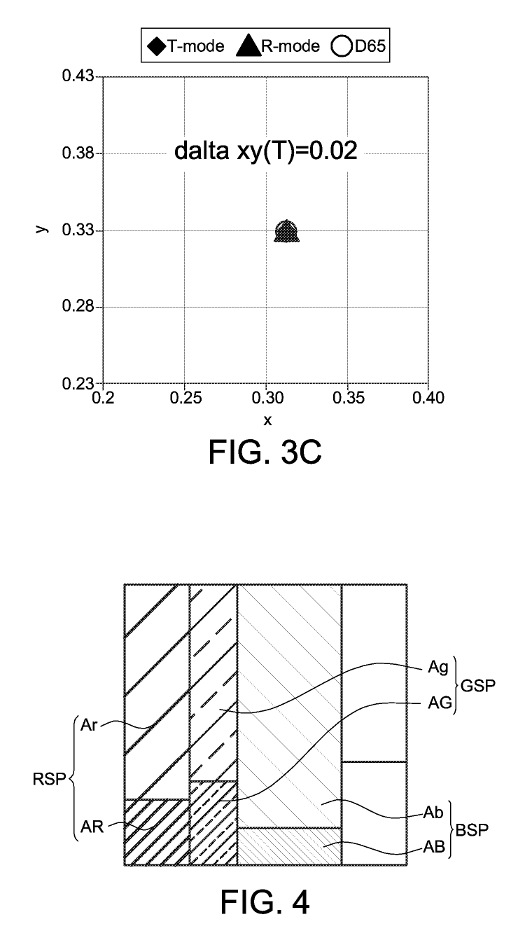

FIG. 3A shows a pixel of a liquid crystal display according to a third embodiment. The sum of the transmissive region AR and the reflective region Ar of the red sub-pixel RSP, the sum of the transmissive region AG and the reflective region Ag of the green sub-pixel GSP, and the sum of the transmissive region AB and the reflective region Ab of the blue sub-pixel BSP can be different from each other. For example, the sum of the transmissive region AR and the reflective region Ar of the red sub-pixel RSP is less than the sum of the transmissive region AB and the reflective region Ab of the blue sub-pixel BSP, and is more than the sum of the transmissive region AG and the reflective region Ag of the green sub-pixel GSP.

Referring to FIG. 3A, the ratio of the transmissive region AB to the reflective region Ab of the blue sub-pixel BSP, the ratio of the transmissive region AR to the reflective region Ar of the red sub-pixel RSP, and the ratio of the transmissive region AG to the reflective region Ag of the green sub-pixel GSP are different from each other. For example, the transmissive region AR of the red sub-pixel RSP is more than the transmissive region AB of the blue sub-pixel BSP, and is less than the transmissive region AG of the green sub-pixel GSP. In addition, the reflective region Ar of the red sub-pixel RSP is less than the reflective region Ab of the blue sub-pixel BSP, and is more than the reflective region Ag of the green sub-pixel GSP. According to some embodiments, the ratio of the transmissive region AR to the reflective region Ar of the red sub-pixel RSP can be more than the ratio of the transmissive region AB to the reflective region Ab of the blue sub-pixel BSP, and less than the ratio of the transmissive region AG to the reflective region Ag of the green sub-pixel GSP.

According to the third embodiment, the voltage Vg applied to the green sub-pixel GSP is lower than the voltage Vr applied to the red sub-pixel RSP, and is higher than the voltage Vb applied to the blue sub-pixel BSP.

For example, FIG. 3B shows voltage-dependent intensity curves of the liquid crystal display according to the third embodiment. FIG. 3C is a schematic diagram illustrating display colors expressed by the liquid crystal display according to the third embodiment.

In an embodiment, the deviation value between the target white point D65 and the reflective white point is set to zero (delta xy (R)=0) (FIG. 3C). In addition, the transmittance of the liquid crystal display is set to 2.0% (T %=2.0%). Under the above conditions (delta xy (R)=0 and T %=2.0%), the deviation value between the target white point D65 and the transmissive white point being 0.00 (delta xy (T)=0.00) (FIG. 3C) is obtained as the voltage Vr (FIG. 3B) is 6.0V, the voltage Vg is 5.0V, and the voltage Vb is 4.2V. The intensity of the red sub-pixel RSP is 100% under the voltage Vr. The intensity of the green sub-pixel GSP is 100% under the voltage Vg. In addition, the intensity of the blue sub-pixel BSP is 100% under the voltage Vr. The reflection of the pixel is 2.2% (R %=2.2%). Accordingly, the delta xy (T) and the R % can be improved under the same T % and delta xy (R).

FIG. 4 shows a pixel of a liquid crystal display according to a fourth embodiment. The pixel shown in FIG. 4 is different from the pixel shown in FIG. 3A in that the pixel further comprises an additional sub-pixel having a color different from the red sub-pixel RSP, the green sub-pixel GSP and the blue sub-pixel BSP. For example, the color of the additional sub-pixel can be a white color or a yellow color.

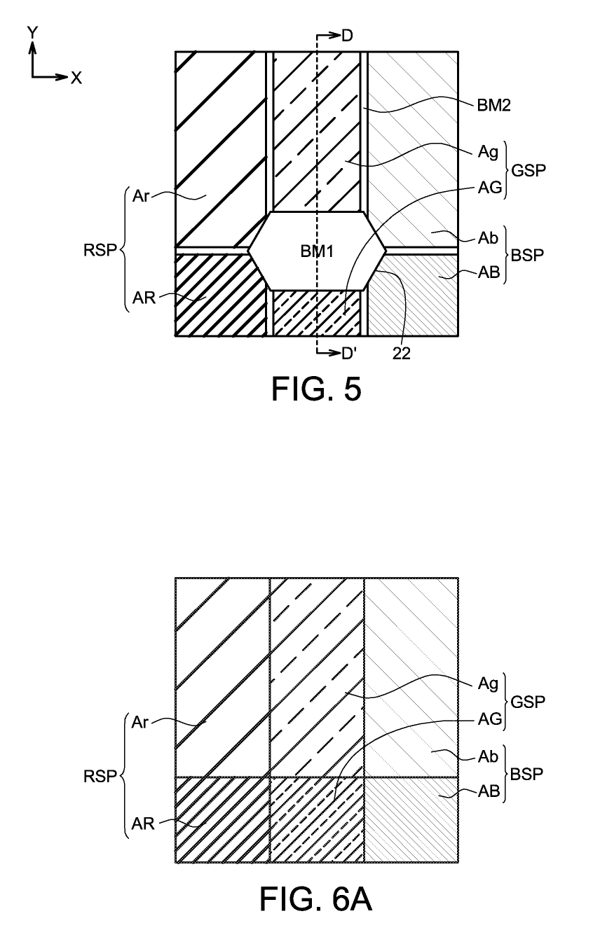

FIG. 5 shows a pixel of a liquid crystal display according to a fifth embodiment. Please referring back to FIG. 1 D, FIG. 1D can also shows a cross-sectional view of FIG. 5 taken along a D-D′ line. Referring to FIG. 5 and FIG. 1D, the shielding layer 22 can include a black matrix BM1 and a black matrix BM2, used for defining the transmissive regions AR, AG, AB, the reflective regions Ar, Ag, Ab of the red sub-pixel RSP, the green sub-pixel GSP, the blue sub-pixel BSP. The black matrix BM1 can extend along a row direction (X direction), the black matrix BM2 can extend along a column direction (Y direction), and the black matrix BM1 and the black matrix BM2 can be substantially perpendicular to each other. As one skilled in the art knows, scanning lines (not shown) are arranged along the row direction, and data lines (not shown) are arranged along the column direction.

In some embodiments, the shielding layer 22 can be arranged to shield different areas in different sub-pixels. For example, in FIG. 5, along the column direction Y, a portion of the black matrix BM1 in the green sub-pixel GSP is wider than a portion of the black matrix BM1 in the red and blue sub-pixels RSP and GSP. That is, the black matrix BM1 in the green sub-pixel GSP shields a larger area than the black matrix BM1 in the red and blue sub-pixels RSP and GSP. In this way, by arranging the shielding area of the shielding layer in different sub-pixels, the ratio of the transmissive region to the reflective region of the different sub-pixels can be adjusted.

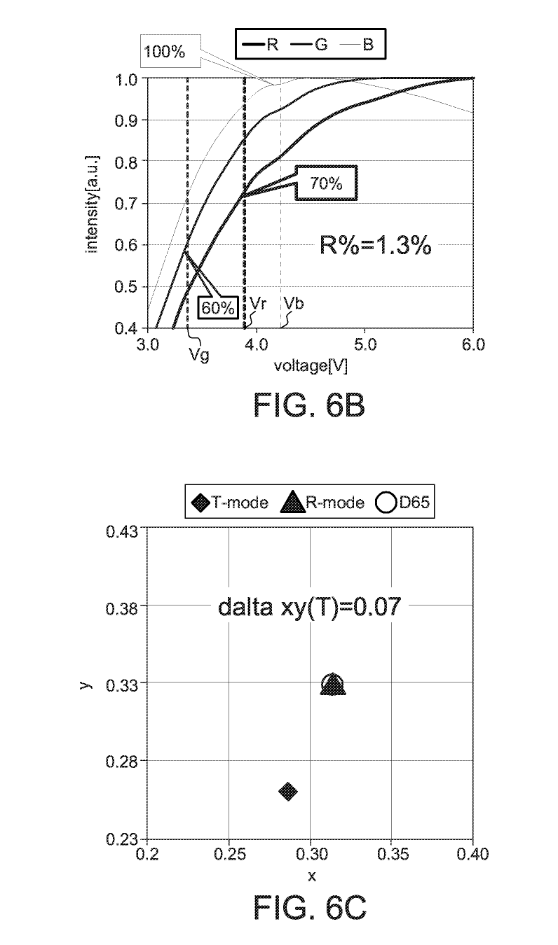

FIG. 6A shows a pixel of a transflective liquid crystal display according to a comparative example. The ratio of the transmissive region AB to the reflective region Ab of the blue sub-pixel BSP, the ratio of the transmissive region AR to the reflective region Ar of the red sub-pixel RSP, and the ratio of the transmissive region AG to the reflective region Ag of the green sub-pixel GSP are the same.

For example, FIG. 6B shows voltage-dependent intensity curves of the liquid crystal display of the comparative example. FIG. 6C is a schematic diagram illustrating display colors expressed by the liquid crystal display of the comparative example.

In the comparative example, the deviation value between the target white point D65 and the reflective white point is set to zero (delta xy (R)=0) (FIG. 6C). In addition, the transmittance of the liquid crystal display is set to 2.0% (T %=2.0%). Under the above conditions (delta xy (R)=0 and T %=2.0%), the optimized deviation value between the target white point D65 and the transmissive white point being 0.07 (delta xy (T)=0.07) (FIG. 6C) is obtained as the voltage Vr (FIG. 6B) is 3.9V, the voltage Vg is 3.4V, and the voltage Vb is 4.2V. The intensity of the red sub-pixel RSP is 70% under the voltage Vr. The intensity of the green sub-pixel GSP is 60% under the voltage Vg. In addition, the intensity of the blue sub-pixel BSP is 100% under the voltage Vr. The reflection of the pixel is 1.3% (R %=1.3%). Accordingly, the delta xy (T) and the R % of the comparative example are worse than the delta xy (T) and the R % according to embodiments.

According to the disclosed embodiments, a ratio of a transmissive region to a reflective region of a blue sub-pixel is different from a ratio of a transmissive region to a reflective region of a sub-pixel having a color different from the blue color, and a voltage applied to the sub-pixel having the color different from the blue color is higher than a voltage applied to the blue sub-pixel. In some embodiments, the result shows that a LC efficiency and a white point of a transflective liquid crystal display can be improved at the same time.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A transflective liquid crystal display, comprising a plurality of pixels, wherein at least one of the plurality of the pixels comprises:
a first sub-pixel having a blue color; and
a second sub-pixel having a color different from the blue color, each of the first sub-pixel and the second sub-pixel having a transmissive region and a reflective region,
wherein a ratio of the transmissive region to the reflective region of the first sub-pixel is different from a ratio of the transmissive region to the reflective region of the second sub-pixel; and wherein a first voltage is applied to the first sub-pixel, a second voltage is applied to the second sub-pixel, and the second voltage is different from the first voltage.

2. The transflective liquid crystal display according to claim 1, wherein the ratio of the transmissive region to the reflective region of the first sub-pixel is less than the ratio of the transmissive region to the reflective region of the second sub-pixel.

3. The transflective liquid crystal display according to claim 1, wherein the second voltage applied to the second sub-pixel is higher than the first voltage applied to the first sub-pixel.

4. The transflective liquid crystal display according to claim 1, wherein a sum of the transmissive region and the reflective region of the first sub-pixel is same to a sum of the transmissive region and the reflective region of the second sub-pixel.

5. The transflective liquid crystal display according to claim 1, wherein a sum of the transmissive region and the reflective region of the first sub-pixel is different from a sum of the transmissive region and the reflective region of the second sub-pixel.

6. The transflective liquid crystal display according to claim 5, wherein the sum of the transmissive region and the reflective region of the first sub-pixel is more than the sum of the transmissive region and the reflective region of the second sub-pixel.

7. The transflective liquid crystal display according to claim 1, further comprising a third sub-pixel having a transmissive region, a reflective region and a color different from the blue color of the first sub-pixel and the color of the second sub-pixel,
wherein a ratio of the transmissive region to the reflective region of the third sub-pixel is different from the ratio of the transmissive region to the reflective region of the first sub-pixel, and
wherein the second sub-pixel has a red color, and the third sub-pixel has a green color.

8. The transflective liquid crystal display according to claim 7, wherein the ratio of the transmissive region to the reflective region of the second sub-pixel is less than the ratio of the transmissive region to the reflective region of the third sub-pixel and more than the ratio of the transmissive region to the reflective region of the first sub-pixel.

9. The transflective liquid crystal display according to claim 7, wherein a sum of the transmissive region and the reflective region of the first sub-pixel, a sum of the transmissive region and the reflective region of the second sub-pixel, and a sum of the transmissive region and the reflective region of the third sub-pixel are same.

10. The transflective liquid crystal display according to claim 7, wherein a sum of the transmissive region and the reflective region of the first sub-pixel is different from at least one of a sum of the transmissive region and the reflective region of the second sub-pixel and a sum of the transmissive region and the reflective region of the third sub-pixel.

11. The transflective liquid crystal display according to claim 7, wherein a third voltage is applied to the third sub-pixel, and the third voltage is lower than the second voltage applied to the second sub-pixel.

12. The transflective liquid crystal display according to claim 11, wherein at least one of the second voltage applied to the second sub-pixel and the third voltage applied to the third sub-pixel is higher than the first voltage applied to the first sub-pixel.

13. The transflective liquid crystal display according to claim 11, wherein a reflectance intensity of the first sub-pixel is 95% to 100% under the first voltage, a reflectance intensity of the second sub-pixel is 80% to 100% under the second voltage, and a reflectance intensity of the third sub-pixel is 65% to 100% under the third voltage.

14. The transflective liquid crystal display according to claim 13, wherein the reflectance intensity of the first sub-pixel is 95% to 100% under the first voltage, the reflectance intensity of the second sub-pixel is 95% to 100% under the second voltage, and the reflectance intensity of the third sub-pixel is 95% to 100% under the third voltage.
